(19) United States
(12) Patent Application Publication
(10) Pub. No.: US 2025/0229831 A1
(43) Pub. Date: Jul. 17, 2025

(54) METHOD TO CONTROL A STEER-BY-WIRE STEERING SYSTEM OF A ROAD VEHICLE WITH ACTIVE INERTIA FEEDBACK

(71) Applicants: Thyssenkrupp Presta AG, Eschen (LI); HONDA MOTOR CO., LTD., Tokyo (JP)

(72) Inventors: Munetsugu HANJI, Wako-shi (JP); Imre SZEPESSY, Mauren (LI); Yoshinobu WATANABE, Wako-shi (JP); Marco MARTEN, Sevelen (CH)

(21) Appl. No.: 19/170,363

(22) Filed: Apr. 4, 2025

Related U.S. Application Data
(63) Continuation of application No. PCT/EP2022/077751, filed on Oct. 5, 2022.

(51) Int. Cl. B62D 6/00

(52) U.S. Cl. CPC B62D 6/008

(57) ABSTRACT

A method to control a steer-by-wire steering system for a vehicle including a steering wheel, a road wheel actuator to actuate wheels, and a feedback actuator to apply a feedback torque to the steering wheel, includes providing steering wheel angular acceleration, steering wheel angular speed and vehicle speed to a controller, deciding based on the steering wheel angular acceleration whether the steering wheel is accelerating in or decelerating against a turning direction, and calculating a steering wheel torque with a tuning map by the controller, calculating a vehicle speed gain with a vehicle speed tuning map applied to the vehicle speed by the controller, deciding whether the steering wheel turns clockwise or counterclockwise based on the steering wheel angular speed by the controller, calculating an output torque counteracting the acceleration of the steering wheel based on results of the previous steps, and sending the output torque to the feedback actuator.

### CROSS REFERENCE TO RELATED APPLICATIONS

This application claims the benefit of priority to Continuation Application of PCT Application No. PCT/EP2022/077751 filed on Oct. 5, 2022. The entire contents of this application are hereby incorporated herein by reference.

### BACKGROUND OF THE INVENTION

### 1. Field of the Invention

The present invention relates to methods to control steer-by-wire steering systems of road vehicles and to steer-by-wire steering systems for road vehicles.

### 2. Description of the Related Art

In a steer-by-wire steering system, the vehicle's steering wheel is disengaged from the steering mechanism. In such a steering system, there is no mechanical coupling between the steering wheel and the steering gear. Steering movement is achieved by a steering actuator with an electric motor. The steering actuator operates in response to detected values of various steering parameters, such as steering wheel angle and vehicle speed, etc. The detected values are communicated electronically to the steering actuator from sensors, whereby the electric motor drives the rack and orients the steerable wheels in the desired direction.

Even though the mechanical linkage between the steering wheel and the road wheels has been eliminated, a steer-by-wire steering system is expected to produce the same functions and steering feel as a conventional mechanically linked steering system. The forces generated in moving the road wheels have to be fed back to the steering wheel to provide information for directional control to the driver. The feedback also contributes to a feeling of steering referred to as steering feel. In steer-by-wire steering systems, the feedback and steering feel respectively is generated with a feedback actuator connected to the steering wheel.

In any accelerating mass system, the accelerating force moment is opposed by an inertial force, which attempts to provide resistance to the change in motion.

The same applies to steering systems. If the steering system with its moving components such as the rack, steering rods, wheels, rotor of the powerpack, steering gear components, the steering wheel, the suspension, and so on is accelerated of decelerated in one direction, inertia will counteract the change in motion. This characteristic has the effect of limiting/restricting high accelerations of the steering wheel angle. In conventional steering systems, the driver also experiences the corresponding inertial forces/moments at the steering wheel because there is a mechanical connection between the steering gear and the steering wheel. In steer-by-wire vehicles, this inertial component of the steering feel is only partially present. Only the inertia of the moving masses of the upper steering column is fed back to the driver as feedback and slows down the acceleration of the steering wheel. The inertia of the lower steering system components is missing.

From DE 10 2017 222 952 A1, it is known to adapt the steering feel via scaling factors that include inertia. A respective scaling factor is calculated, which results from the ratio of the reference ratio to the current ratio. The input values for inertia are steering wheel acceleration, driving torque and vehicle speed.

### SUMMARY OF THE INVENTION

Example embodiments of the present invention provide methods for steer-by-wire steering systems of road vehicles by which inertia feedback can be actively controlled and steering accelerations can be limited.

An example embodiment of the present invention provides a method to control a steer-by-wire steering system for a road vehicle, the steer-by-wire steering system including a steering wheel, a road wheel actuator to actuate road wheels, and a feedback actuator to apply a feedback torque to the steering wheel, the method including providing steering wheel angular acceleration with a sign, steering wheel angular speed with a sign and vehicle speed to a controller of the feedback actuator, deciding based on the steering wheel angular acceleration whether the steering wheel is accelerating in a direction of turning or deaccelerating against a direction of turning, and calculating a corresponding steering wheel torque with a corresponding tuning map by the controller, calculating a vehicle speed gain with a vehicle speed tuning map applied to the vehicle speed by the controller, deciding whether the steering wheel turns clockwise or counterclockwise based on the steering wheel angular speed by the controller, calculating an output torque counteracting the acceleration of the steering wheel based on the results of steps b, c and d, and sending the output torque to the feedback actuator.

The method replicates fully artificial steering inertia at the feedback actuator, resulting in relaxed driving by reducing or preventing unconscious steering. The artificial steering inertia is preferably similar in design to conventional vehicles with electromechanical steering systems. Although steer-by-wire systems have no inertia of I-shaft, rack, suspension and tires, the steering feel of inertia can be mimicked via the calculated output torque. In conventional electromechanical steering systems, inertia has the effect of slowing down a fast movement at the beginning of an unconscious steering process, where the steering acceleration tends to increase. The artificial steering inertia represented by the output torque can imitate this behavior of conventional steering systems.

Further, it is possible to adapt the fully artificial steering inertia and thus adapt the behavior of the steering system to the vehicle type. Feedback actuators of known steer-by-wire system reproduce a constant inertia, regardless of the vehicle type. However, for electromechanical steering systems, the inertia is affected by the inertia of rack and pinion, suspension, and tires, and thus depends on the vehicle size. Larger vehicles have a larger inertia moment. The different inertias of different vehicle types affect the steering feel. Luxury vehicles, for example, have a certain inertia and give an elegant and relaxed steering feel. Sporty vehicles have low inertia and give a sporty and direct steering feel. With the artificial steering inertia represented by the calculated output torque, it is possible to adapt the inertia of the steer-by-wire system to the vehicle type, as would be the case with electromechanical steering systems.

The artificial inertia is designed to provide a desired steering feel and it can be tuned dynamically.

The output torque is preferably added to the sum of other functions, wherein the resulting torque is used to control the feedback actuator. Preferably, a limiter is used, which is applied on either the output torque or on a final block of a motor control torque.

Preferably, the method is performed whenever the feedback actuator is active and the steering wheel is moving and accelerating.

It is advantageous if the tuning maps are predefined and based on measured values of comparative electromechanical steering systems, thus perfectly reproducing inertia of such steering systems or they can be predefined arbitrarily, in which case an engineer tunes the map based on evaluation.

In order to reproduce inertia, the tuning maps used in step b preferably include at least one function that results in higher steering wheel torque output values for higher steering wheel acceleration and in lower steering wheel torque output values for lower steering wheel acceleration.

It is preferred that the vehicle speed tuning map used in step c includes at least one function that results in a higher vehicle speed gain for higher vehicle speeds and in a lower vehicle speed gain at lower vehicle speeds.

In another example embodiment of the present invention, a steer-by-wire steering system for a road vehicle designed to perform the above-described method is provided.

The above and other elements, features, steps, characteristics and advantages of the present invention will become more apparent from the following detailed description of the example embodiments with reference to the attached drawings.

### BRIEF DESCRIPTION OF THE EXAMPLE EMBODIMENTS

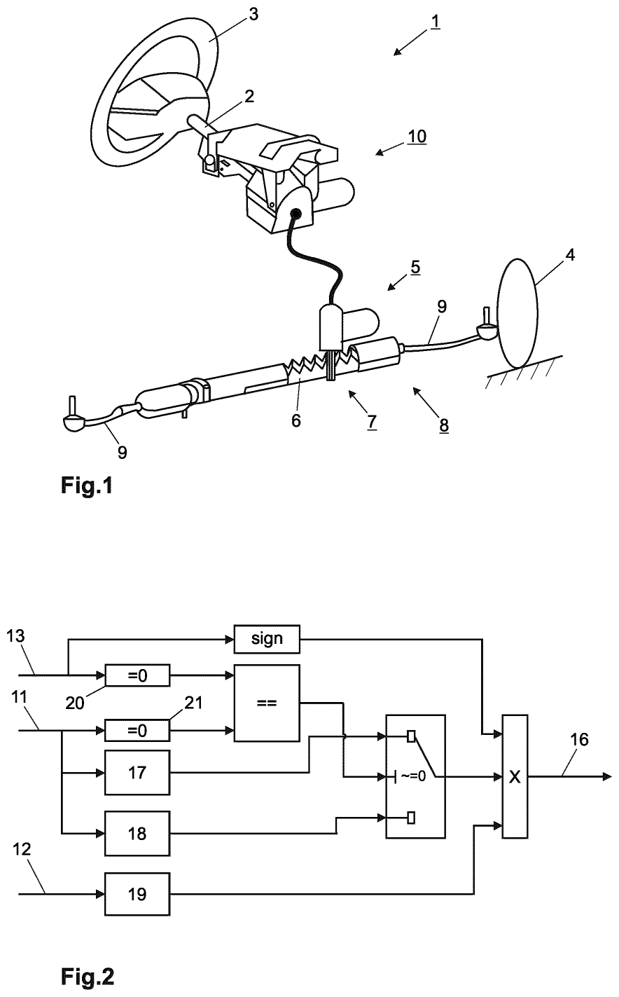

FIG. 1 is a schematic illustration of a steer-by-wire steering system of a motor vehicle.

FIG. 2 shows a block diagram of a method which artificially reproduces steering inertia at the feedback actuator.

### DETAILED DESCRIPTION OF THE EXAMPLE EMBODIMENTS

FIG. 1 is a schematic drawing of a steer-by-wire system 1 with a steering shaft 2 connected to a steering wheel 3. There is no mechanical connection between the steering wheel 3 and road wheels 4. A road wheel actuator 5 operates a gear rack 6 via a rack-and-pinion gear 7, which is part of a front wheel axle 8. The front wheel axle 8 includes two tie rods 9 for road wheels 4, of which only one road wheel 4 is sketched.

When a driver operates the steering wheel 3, steering shaft 2 is rotated, which is detected by a shaft sensor, which is not shown in the drawings. When the vehicle is switched on, a controller is configured or programmed to calculate an operation signal for the road wheel actuator 5 from the signal detected by the shaft sensor. By operating gear rack 6 with the operation signal, the front wheel axle 8 is moved sideways and the road wheels 4 are turned. At the same time, forces introduced in the wheel axle 8 from the road wheels 4 are recognized by another sensor not shown in the drawings, and a feedback signal is calculated, which is applied to the steering shaft 2 by a feedback actuator 10, so that the operator can recognize the feedback in the steering wheel 3.

FIG. 2 shows schematically a block diagram of a method to control the steering system with artificial inertia feedback.

The method uses steering wheel angular acceleration 11 with a sign and vehicle speed 12 as input values. Further, the steering wheel angular speed 13 with a sign is used as an input value to detected whether the steering wheel is turning clockwise or counter-clockwise. The sign of the steering wheel angular acceleration 11 is used to decide whether the steering wheel is accelerated in the direction of movement (forward) 14 or deaccelerated accordingly in the other direction (backward) 15.

These case distinctions are important in order to assign the correct sign to the resulting output torque 16. The resulting output torque 16 simulates the characteristics of inertia. Accordingly, the output torque 16 is a counter-torque at the steering wheel, which counteracts the movement of the steering wheel.

The steering wheel angular acceleration 11 is factorized with a tuning map 17, 18. There are two different tuning maps 17, 18. A tuning map 17 for forward movement and a tuning map 18 for backward movement.

When moving forward, in conventional electromechanical steering systems, inertia slows down the driver's steering maneuver. The higher the acceleration, the higher the resulting counter-torque at the steering wheel. This is mimicked by the corresponding tuning map 17.

In backward situations, inertia counteracts deacceleration in conventional electromechanical steering systems. This can lead to a poor steering feel. Preferably, the influence on the steering feel of inertia during deacceleration is reduced compared to conventional electromechanical steering systems and to forward steering for the same absolute value of steering wheel acceleration.

Since the inertia of the steering system depends on the vehicle speed 12, this is included in the calculation of the output torque. A tunable map 19 is provided which is dependent on vehicle speed. The tunable map 19 determines a factor, which is multiplied with the steering wheel angular acceleration and thus contributes to the value of the resulting output torque 16.

The resulting output torque 16 generates a fully artificial and tunable inertia feedback. The output torque 16 is added to other functions such as reaction torque. The total sum is used to control the feedback actuator. If the steering wheel is not turning 20 and/or not accelerating 21, the output torque 16 is zero.

The tuning maps 17, 18, 19 are preferably predefined and installed at the factory. However, it is possible to amend or replace the tuning maps 17, 18, 19, for example, via software update later on. The tuning maps can be predefined arbitrarily, in which case an engineer tunes the map based on evaluation. The tuning maps are pre-implemented in the software, and engineers set the tuning values based on their feeling or measured characteristics of a comparative system. It is possible to account for vehicle type specific inertia. It is also possible to implement a learning mechanism for personalized experience. In this case, target inertia characteristics can be updated through everyday usage.

The described method is preferably always performed when the feedback actuator is active. The inertia of the steering system is thus artificially imitated depending on the angular acceleration of the steering wheel and the vehicle speed.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method to control a steer-by-wire steering system for a road vehicle, the steer-by-wire steering system including a steering wheel, a road wheel actuator to actuate road wheels, and a feedback actuator to apply a feedback torque to the steering wheel, the method comprising:
a) providing steering wheel angular acceleration with a sign, steering wheel angular speed with a sign and vehicle speed to a controller of the feedback actuator;
b) deciding based on the steering wheel angular acceleration whether the steering wheel is accelerating in a direction of turning or deaccelerating against a direction of turning, and calculating a corresponding steering wheel torque with a corresponding tuning map by the controller;
c) calculating a vehicle speed gain with a vehicle speed tuning map applied to the vehicle speed by the controller;
d) deciding whether the steering wheel turns clockwise or counterclockwise based on the steering wheel angular speed by the controller;
e) calculating an output torque counteracting the acceleration of the steering wheel based on the results of steps b, c and d; and
f) sending the output torque to the feedback actuator.

2. The method according to claim 1, wherein the method is performed whenever the feedback actuator is active and the steering wheel is moving and accelerating or deaccelerating.

3. The method according to claim 1, wherein the tuning maps are predefined and an inertia impact of a backward tuning map is less than an inertia impact of a forward tuning map for a same absolute value of steering wheel acceleration.

4. The method according to claim 1, wherein the tuning maps used in step b include at least one function that results in higher steering wheel torque output values for higher steering wheel acceleration or deacceleration and in lower steering wheel torque output values for lower steering wheel acceleration or deacceleration.

5. The method according to claim 1, wherein the vehicle speed tuning map used in step c includes at least one function that results in a higher vehicle speed gain for higher vehicle speeds and in a lower vehicle speed gain for lower vehicle speeds.

6. The method according to claim 1, wherein the tuning maps are chosen to reflect a vehicle type specific moment of inertia.

7. A steer-by-wire steering system for a road vehicle configured to perform the method according to claim 1.
